(19) United States
(12) Patent Application Publication
(10) Pub. No.: US 2004/0216378 A1
(43) Pub. Date: Nov. 4, 2004

(54) Plasma fuel reformer having a shaped catalytic substrate positioned in the reaction chamber thereof and method for operating the same

(76) Inventor: Rudolf M. Smaling, Bedford, MA (US)

Correspondence Address: BARNES & THORNBURG, 11 SOUTH MERIDIAN, INDIANAPOLIS, IN, 46204

(21) Appl. No.: 10/425,928

(22) Filed: Apr. 29, 2003

(51) Int. Cl. B01J 8/00

(52) U.S. Cl. 48/198.7; 48/197 R; 48/127.9

(57) ABSTRACT

A plasma fuel reformer reforms hydrocarbon fuels to produce a reformed gas which is supplied to the intake of an internal combustion engine, an emission abatement device, or a fuel cell. The plasma fuel reformer includes a catalytic substrate positioned in the reaction chamber of the plasma fuel reformer to facilitate the reforming process of gas exiting the plasma-generating assembly of the reformer. A method of operating a plasma fuel reformer is also disclosed.

### FIELD OF THE DISCLOSURE

The present disclosure relates generally to a fuel reformer, and more particularly to a plasma fuel reformer and a method for operating the same.

### BACKGROUND

Plasma fuel reformers reform hydrocarbon fuel into a reformate gas such as hydrogen-rich gas. In the case of an onboard plasma fuel reformer of a vehicle or stationary power generator, the reformate gas produced by the reformer may be utilized as fuel or fuel additive in the operation of an internal combustion engine. The reformate gas may also be utilized to regenerate or otherwise condition an emission abatement device associated with an internal combustion engine or as a fuel for a fuel cell.

### SUMMARY

According to one aspect of the disclosure, there is provided a plasma fuel reformer. The plasma fuel reform reforms hydrocarbon fuel to produce a reformate gas. The plasma fuel reformer includes a reactor housing having a catalytic substrate positioned therein. The catalytic substrate is spaced apart from the walls of the reactor housing so as not to contact the surface thereof.

The catalytic substrate may be cylindrically-shaped. The catalytic substrate may be embodied as a rolled mesh screen with a catalytic material disposed thereon.

A method of operating a plasma fuel reformer is also disclosed herein. The method includes the step of advancing a fuel through a plasma arc to generate a partially reformed gas. The partially reformed gas is advanced into an inner region of a catalytic substrate without passing through the substrate. The partially reformed gas is then advanced out of the inner region, through the substrate, and into a reaction chamber associated with the plasma fuel reformer.

The partially reformed gas does not contact the walls of the reaction chamber prior to advancement thereof through the catalytic substrate.

The above and other features of the present disclosure will become apparent from the following description and the attached drawings.

### BRIEF DESCRIPTION OF THE DRAWINGS

The detailed description particularly refers to the accompanying figures in which:

FIG. 1 is a cross sectional view of a plasma fuel reformer having a cylindrically-shaped catalytic substrate, note that the fuel injector and the catalytic substrate are not shown in cross section for clarity of description;

FIG. 2 is a view similar to FIG. 1, but showing a plasma fuel reformer having a frusto-conically-shaped catalytic substrate; and

FIG. 3 is a view similar to FIG. 1, but showing a plasma fuel reformer having a spherically-shaped catalytic substrate.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

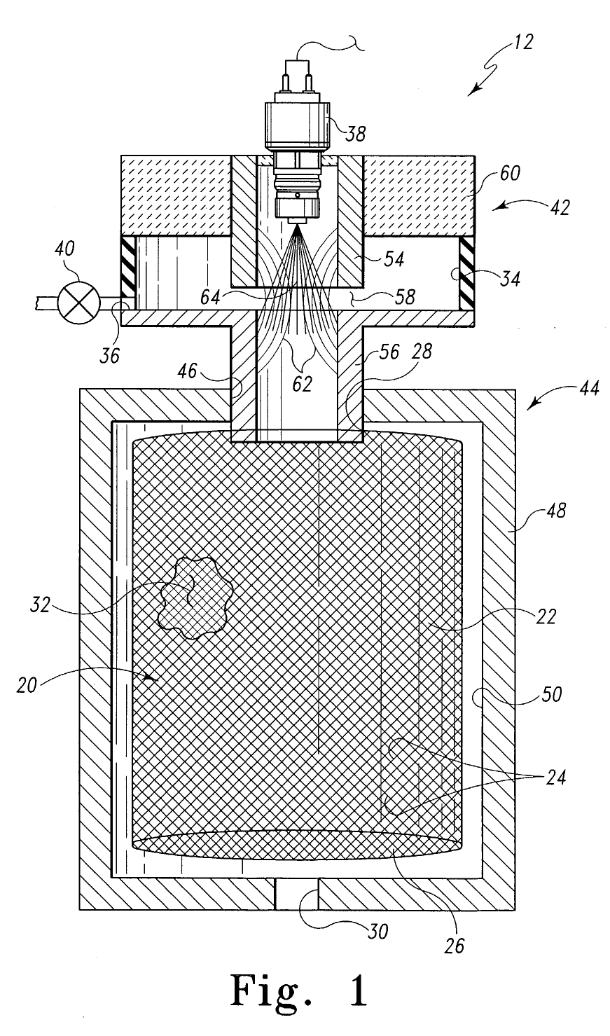

Referring now to FIGS. 1-3, there is shown a plasma fuel reformer 12. The plasma fuel reformer 12 reforms (i.e., converts) hydrocarbon fuels into a reformate gas that includes, amongst other things, hydrogen and carbon monoxide. As such, the plasma fuel reformer 12, amongst other uses, may be used in the construction of an onboard fuel reforming system of a vehicle or stationary power generator. In such a way, the reformate gas produced by the plasma fuel reformer 12 may be utilized as fuel or fuel additive in the operation of an internal combustion engine thereby increasing the efficiency of the engine while also reducing emissions produced by the engine. The reformate gas from the plasma fuel reformer 12 may also be utilized to regenerate or otherwise condition an emission abatement device associated with an internal combustion engine. In addition, if the vehicle or the stationary power generator is equipped with a fuel cell such as, for example, an auxiliary power unit (APU), the reformate gas from the plasma fuel reformer 12 may also be used as a fuel for the fuel cell. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference. Additional examples of systems including plasma fuel reformers are disclosed in copending U.S. patent application Ser. No. 10/158,615 entitled “Low Current Plasmatron Fuel Converter Having Enlarged Volume Discharges” which was filed on May 30, 2002 by A. Rabinovich, N. Alexeev, L. Bromberg, D. Cohn, and A. Samokhin, along with copending U.S. patent application Ser. No. 10/411,917 entitled “Plasmatron Fuel Converter Having Decoupled Air Flow Control” which was filed on Apr. 11, 2003 by A. Rabinovich, N. Alexeev, L. Bromberg, D. Cohn, and A. Samokhin, the disclosures of both of which are hereby incorporated by reference.

The plasma fuel reformer 12 includes a plasma-generating assembly 42 and a reactor 44. The reactor 44 includes a reactor housing 48 having a reaction chamber 50 defined therein. The plasma-generating assembly 42 is secured to an upper portion of the reactor housing 48. The plasma-generating assembly 42 includes an upper electrode 54 and a lower electrode 56. The electrodes 54, 56 are spaced apart from one another so as to define an electrode gap 58 therebetween. An insulator 60 electrically insulates the electrodes from one another.

The electrodes 54, 56 are electrically coupled to an electrical power supply (not shown) such that, when energized, an electrical current is supplied to one of the electrodes thereby generating a plasma arc 62 across the electrode gap 58 (i.e., between the electrodes 54, 56). A fuel input mechanism such as a fuel injector 38 injects a hydrocarbon fuel 64 into the plasma arc 62. The fuel injector 38 may be any type of fuel injection mechanism which injects a desired amount of fuel into plasma-generating assembly 42. In certain configurations, it may be desirable to atomize the fuel prior to, or during, injection of the fuel into the plasma-generating assembly 42. Such fuel injector assemblies (i.e., injectors which atomize the fuel) are commercially available.

The plasma-generating assembly 42 has an annular air chamber 34. Pressurized air is advanced into the air chamber 34 through an air inlet 36 and is thereafter directed radially inwardly through the electrode gap 58 so as to “bend” the plasma arc 62 inwardly. Such bending of the plasma arc 62 ensures that the injected fuel 64 is directed through the plasma arc 62. Such bending of the plasma arc 62 also reduces erosion of the electrodes 56, 58. Moreover, advancement of air into the electrode gap 58 also produces a desired mixture of air and fuel (“air/fuel mixture”). In particular, the plasma reformer 12 reforms or otherwise processes the fuel in the form of a mixture of air and fuel. The air-to-fuel ratio of the mixture being reformed by the fuel reformer is controlled via control of an air inlet valve 40. The air inlet valve 40 may be embodied as any type of electronically-controlled air valve. The air inlet valve 40 may be embodied as a discrete device, or may be integrated into the design of the plasma fuel reformer 12. In either case, the air inlet valve 40 controls the amount of air that is introduced into the plasma-generating assembly 42 thereby controlling the air-to-fuel ratio of the air/fuel mixture being processed by the plasma fuel reformer 12.

The lower electrode 56 is, in essence, the outlet of the plasma-generating assembly 42 and extends downwardly through an inlet 46 defined in the reactor housing 48. However, it should be appreciated that the plasma-generating assembly 42 may be embodied to include a separate outlet. In any case, gas (either reformed or partially reformed) exiting the plasma arc 62 is advanced into the reaction chamber 50. Upon entry into the reaction chamber 50, the reformed or partially reformed gas is advanced through a catalytic substrate 20 positioned in the reaction chamber 50. The catalytic substrate 20 furthers the fuel reforming process, or otherwise treats the reformed or partially reformed gas, prior to exit of the gas through a gas outlet 30. In particular, some or all of the gas exiting the plasma-generating assembly 42 may only be partially reformed, and the catalytic substrate 20 is configured to complete or otherwise further the reforming process (i.e., catalyze a reaction which completes or otherwise furthers the reforming process of the partially reformed gas exiting the plasma-generating assembly 42).

The catalytic substrate 20 may be embodied as any type of catalyst that is configured to catalyze such reactions. In one exemplary embodiment, the catalytic substrate 20 is embodied as substrate body 22 having a precious metal or other type of catalytic material disposed thereon. Such a substrate body 22 may be constructed of ceramic, metal, or other suitable material. The catalytic material may be any desired catalyst material for catalyzing a desired chemical reaction of the gases advancing through the substrate 20. For example, the catalytic material may be embodied as platinum, rhodium, palladium, including combinations thereof, along with any other similar catalytic materials. In a more specific exemplary embodiment, the catalytic material is a platinum-group metal. In an even more specific exemplary embodiment, the catalytic material is platinum-palladium.

The substrate body 22 has a number of orifices 24 defined therein. The orifices 24 may be embodied in any shape, configuration, or size. Moreover, the number and location of the orifices 24 may be configured in any number of configurations to the fit the needs of a given substrate design. The substrate body 22 may take the form of a solid body into which the orifices 24 are drilled or otherwise machined, or, alternatively, a material containing such orifices may be used. In particular, in an exemplary embodiment, the substrate body 22 is constructed by rolling a mesh screen material into a desired shape such as the cylindrically-shaped substrate body 22 shown in FIG. 1. A solid or screened bottom cap 26 is secured to a lower end of the substrate body 22. In such a case (i.e., a substrate body 22 constructed from a mesh screen material), the catalytic material (e.g., platinum-palladium) is coated or otherwise disposed on the mesh screen.

The catalytic substrate 20 is positioned in the reaction chamber 50 such that substantially all of the reformed or partially reformed gas exiting the plasma arc 62 is advanced therethrough. In particular, an upstream end of the catalytic substrate 20 is positioned proximate to the plasma-generating assembly 12, with a downstream end of the substrate 20 being positioned proximate to the gas outlet 30. Moreover, the lower electrode 56 extends downwardly through an inlet 28 defined in the upstream end of the catalytic substrate 20. As such, gas exiting the plasma-generating assembly 42 is advanced into a hollow interior region 32 of the catalytic substrate 20 thereby necessitating that the gas pass through the substrate 20 prior to being exhausted through the gas outlet 30. It should be appreciated that similar results may also be obtained if the downstream edge of the lower electrode 56 was abutted to the upstream edge of the catalytic substrate 20 (as opposed to extending into the substrate 20).

As shown in FIG. 1, the catalytic substrate 20 is spaced apart from the inner surfaces of the reactor housing 48. In particular, the outer surfaces of the substrate body 22 do not contact the reactor housing 48. In such a way, quenching of the reformed or partially reformed gas exiting the plasma-generating head 42 is avoided. In particular, gas exiting the plasma-generating assembly 42 avoids contact with the walls of the reactor housing 48 prior to passing through the catalytic substrate 20. In certain thermal conditions, wall contact by the gas prior to advancement thereof through the catalytic substrate 20 may cause undesirable quenching of the gas.

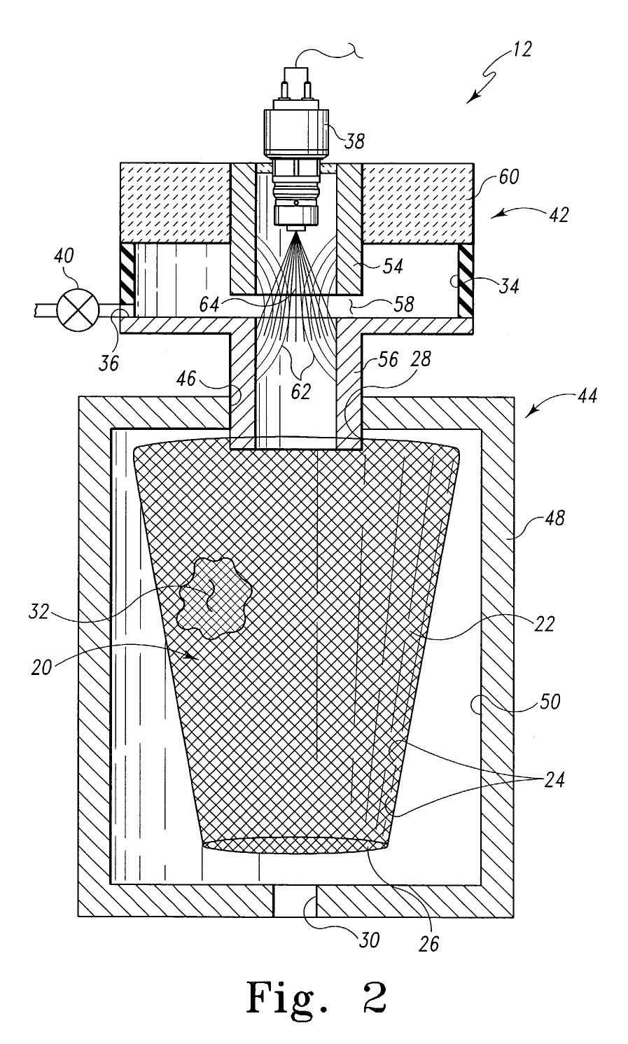

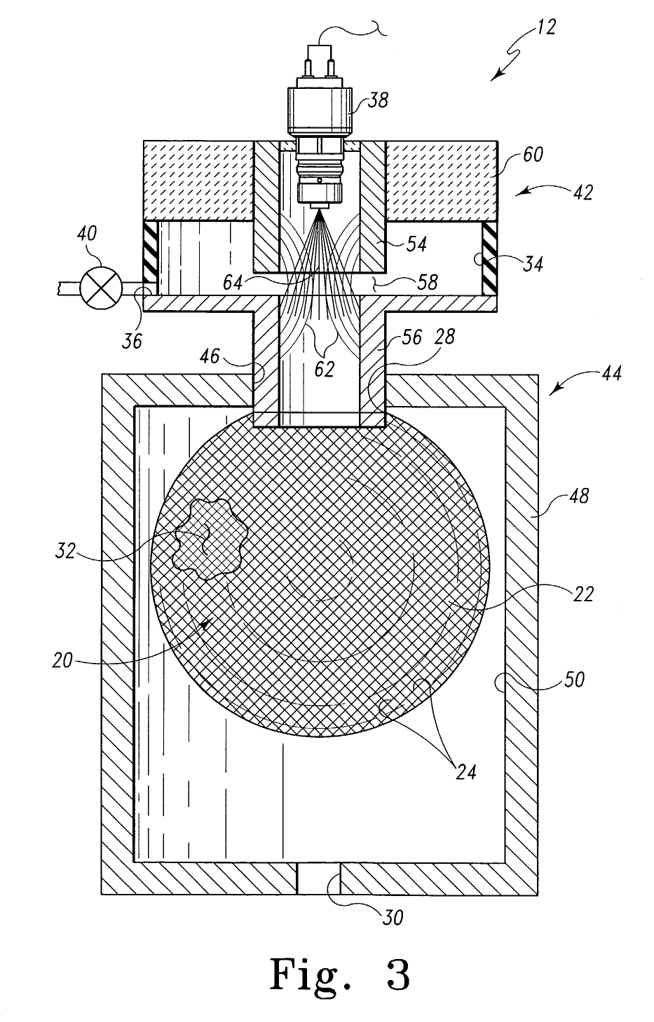

As shown in FIGS. 2 and 3, other configurations of the catalytic substrate 20 are also contemplated. For example, as shown in FIG. 2, a frusto-conically-shaped catalytic substrate 20 may be used. Moreover, as shown in FIG. 3, a generally spherically-shaped catalytic substrate 20 may also be used. It should be appreciated that any number of different shapes may be used in regard to the construction of the catalytic substrate 20. For example, the substrate body 22 may take the form of a pyramid (including a husto-pyramid), a rectangular parallelepiped, a cube, a polyhedron, or any other type of regular or irregular shaped three-dimensional structure.

In operation, the plasma fuel reformer 12 may be operated to reform a hydrocarbon fuel into a reformate gas such as a reformate gas rich in hydrogen and carbon monoxide. To do so, a fuel 64 is injected into a plasma arc 62 which commences the reforming process. Gas exiting the plasma arc 62 is then advanced through the catalytic substrate 20 which completes or otherwise furthers the reforming of the fuel into reformate gas. The reformate gas is then exhausted or otherwise advanced through the gas outlet 30 and thereafter supplied to an external device such as the intake manifold of an internal combustion engine, an emission abatement device, or a fuel cell.

While the disclosure is susceptible to various modifications and alternative forms, specific exemplary embodiments thereof have been shown by way of example in the drawings and has herein be described in detail. It should be understood, however, that there is no intent to limit the disclosure to the particular forms disclosed, but on the contrary, the intention is to cover all modifications, equivalents, and alternatives falling within the spirit and scope of the disclosure.

There are a plurality of advantages of the present disclosure arising from the various features of the apparatus and methods described herein. It will be noted that alternative embodiments of the apparatus and methods of the present disclosure may not include all of the features described yet still benefit from at least some of the advantages of such features. Those of ordinary skill in the art may readily devise their own implementations of an apparatus and method that incorporate one or more of the features of the present disclosure and fall within the spirit and scope of the present disclosure.

1. A plasma fuel reformer, comprising:
a plasma-generating assembly,
a housing secured to the plasma-generating assembly, the housing having an internal wall surface which defines a reaction chamber, and
a catalytic substrate positioned in the reaction chamber, the catalytic substrate having an outer surface, the entirety of which is spaced apart from the inner wall surface of the housing.

2. The plasma fuel reformer of claim 1, further comprising a gas outlet, wherein:
the catalytic substrate has a first end and a second end,
the first end of the catalytic substrate is positioned proximate to the plasma-generating assembly, and
the second end of the catalytic substrate is positioned proximate to the gas outlet.

3. The plasma fuel reformer of claim 2, wherein the catalytic substrate is cylindrical in shape.

4. The plasma fuel reformer of claim 2, wherein the catalytic substrate is conical in shape.

5. The plasma fuel reformer of claim 1, wherein the catalytic substrate is spherical in shape.

6. The plasma fuel reformer of claim 1, wherein the catalytic substrate comprises a mesh screen with a catalyst material disposed thereon.

7. The plasma fuel reformer of claim 6, wherein the mesh screen is cylindrical in shape.

8. A method of operating a fuel reformer, comprising the steps of:
operating a plasma-generating assembly so as to produce a partially reformed gas from a fuel,
advancing the partially reformed gas into an inner region of a catalytic substrate without first passing through the substrate, and
advancing the partially reformed gas out of the inner region and through the catalytic substrate into a reaction chamber.

9. The method of claim 8, wherein the step of advancing the partially reformed gas through the catalytic substrate comprises further reforming the partially reformed gas.

10. The method of claim 8, wherein the step of advancing the partially reformed gas through the catalytic substrate comprises advancing the partially reformed gas through a cylindrically-shaped catalytic substrate.

11. The method of claim 8, wherein the step of advancing the partially reformed gas through the catalytic substrate comprises advancing the partially reformed gas through a conically-shaped catalytic substrate.

12. The method of claim 8, wherein the step of advancing the partially reformed gas through the catalytic substrate comprises advancing the partially reformed gas through a spherically-shaped catalytic substrate.

13. The method of claim 8, wherein the step of advancing the partially reformed gas through the catalytic substrate comprises advancing the partially reformed gas through a mesh screen with a catalyst material disposed thereon.

14. A plasma fuel reformer, comprising:
a plasma-generating assembly having a gas outlet,
a housing secured to the plasma-generating assembly, the housing having a reaction chamber defined therein, and
a catalytic substrate positioned in the reaction chamber, the catalytic substrate having a substrate body defining (i) a hollow inner region, and (ii) an inlet to the hollow inner region, wherein the gas outlet of the plasma-generating assembly is fluidly coupled to the inlet of the substrate body such that fluid is communicated from the gas outlet into the inner region of the substrate body without passing through the substrate.

15. The plasma fuel reformer of claim 14, wherein the substrate body is cylindrical in shape.

16. The plasma fuel reformer of claim 14, wherein the substrate body is conical in shape.

17. The plasma fuel reformer of claim 14, wherein the substrate body is spherical in shape.

18. The plasma fuel reformer of claim 14, wherein the substrate body comprises a mesh screen with a catalyst material disposed thereon.

19. The plasma fuel reformer of claim 18, wherein the mesh screen is cylindrical in shape.

20. The plasma fuel reformer of claim 14, wherein:
the housing comprises a housing wall having an inner wall surface, and
the substrate body of the catalytic substrate is spaced apart from the inner wall surface.
